(19) United States
(12) Patent Application Publication
(10) Pub. No.: US 2023/0354058 A1
(43) Pub. Date: Nov. 2, 2023

(54) ADDING SURROUNDING INFORMATION IN MINIMIZATION OF DRIVE TEST REPORTING

(71) Applicant: QUALCOMM Incorporated, San Diego, CA (US)

(72) Inventors: Bapineedu Chowdary Gummadi, Hyderabad (IN); Xipeng Zhu, San Diego, CA (US); Rajeev Kumar, San Diego, CA (US); Shankar Krishnan, San Diego, CA (US); Xiaoxin Zhang, Sunnyvale, CA (US)

(21) Appl. No.: 17/733,826

(22) Filed: Apr. 29, 2022

(51) Int. Cl. H04W 24/02; H04W 24/10; H04W 16/18

(52) U.S. Cl. CPC H04W 24/02; H04W 24/10; H04W 16/18

(57) ABSTRACT

Methods, systems, and devices for wireless communications are described. A wireless device may receive an indication of a configuration for sensing measurement parameter reporting from a base station. The sensing measurement parameter reporting may be for a sensing operation. The wireless device may perform the sensing operation and transmit an indication of a measurement parameter value to the base station. The sensing measurement parameter value may be associated with a location of the wireless device. In some examples, the wireless device may transmit the indication of the sensing measurement parameter value based on performing the sensing operation.

### FIELD OF TECHNOLOGY

The following relates to wireless communications, including techniques for adding surrounding information in minimization of drive test (MDT) reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some examples of a wireless communications system, a wireless communications network may collect information to determine the network performance at various locations throughout the network coverage area. In some examples, information collection techniques for wireless communications networks may be deficient.

### SUMMARY

The described techniques relate to improved methods, systems, devices, and apparatuses that support techniques for adding surrounding information in minimization of drive test (MDT) reporting. Generally, a wireless communication device may receive an indication of a configuration for sensing measurement parameter reporting from a base station. The sensing measurement parameter reporting may be for a sensing operation. The wireless communication device may perform the sensing operation based on the configuration and transmit an indication of a measurement parameter value to the base station. The sensing measurement parameter value may be associated with a location of the wireless communication device. In some examples, the wireless communication device may transmit the indication of the sensing measurement parameter value based on performing the sensing operation.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

A method for wireless communication at a wireless device is described. The method may include receiving, from a base station, an indication of a configuration for sensing measurement parameter reporting for a sensing operation, performing, by the wireless device, the sensing operation based on the configuration for the sensing measurement parameter reporting, and transmitting, to the base station, an indication of one or more sensing measurement parameter values associated with a location of the wireless device based on performing the sensing operation.

An apparatus for wireless communication at a wireless device is described. The apparatus may include a processor, memory coupled with the processor, and instructions stored in the memory. The instructions may be executable by the processor to cause the apparatus to receive, from a base station, an indication of a configuration for sensing measurement parameter reporting for a sensing operation, perform, by the wireless device, the sensing operation based on the configuration for the sensing measurement parameter reporting, and transmit, to the base station, an indication of one or more sensing measurement parameter values associated with a location of the wireless device based on performing the sensing operation.

Another apparatus for wireless communication at a wireless device is described. The apparatus may include means for receiving, from a base station, an indication of a configuration for sensing measurement parameter reporting for a sensing operation, means for performing, by the wireless device, the sensing operation based on the configuration for the sensing measurement parameter reporting, and means for transmitting, to the base station, an indication of one or more sensing measurement parameter values associated with a location of the wireless device based on performing the sensing operation.

A non-transitory computer-readable medium storing code for wireless communication at a wireless device is described. The code may include instructions executable by a processor to receive, from a base station, an indication of a configuration for sensing measurement parameter reporting for a sensing operation, perform, by the wireless device, the sensing operation based on the configuration for the sensing measurement parameter reporting, and transmit, to the base station, an indication of one or more sensing measurement parameter values associated with a location of the wireless device based on performing the sensing operation.

Some examples of the method, apparatuses, and non-transitory computer-readable medium described herein may further include operations, features, means, or instructions for transmitting, to the base station, a first request to report the one or more sensing measurement parameter values responsive to an event and receiving, responsive to the transmitted first request, a request from the base station for the wireless device to report the one or more sensing measurement parameter values, where transmitting the indication of the one or more sensing measurement parameter values includes transmitting an information response message responsive to receiving the request to report the one or more sensing measurement parameter values.

In some examples of the method, apparatuses, and non-transitory computer-readable medium described herein, the event includes a radio link failure (RLF), a secondary cell group (SCG) failure, a connection establishment failure (CEF), or any combination thereof.

In some examples of the method, apparatuses, and non-transitory computer-readable medium described herein, the information response message may be transmitted via radio resource control (RRC) signaling.

In some examples of the method, apparatuses, and non-transitory computer-readable medium described herein, transmitting the indication of the one or more sensing measurement parameter values may include operations, features, means, or instructions for transmitting, to the base station, a report associated with a quality of experience.

Some examples of the method, apparatuses, and non-transitory computer-readable medium described herein may further include operations, features, means, or instructions for determining channel state information (CSI) based on the sensing operation, where the indication of the one or more sensing measurement parameter values may be based on the determined CSI.

In some examples of the method, apparatuses, and non-transitory computer-readable medium described herein, the one or more sensing measurement parameter values include one or more of user equipment (UE) space information, one or more enclosed space dimensions, an enclosed space type, people information, animal information, object information, material type information, or a UE motion state.

Some examples of the method, apparatuses, and non-transitory computer-readable medium described herein may further include operations, features, means, or instructions for estimating the one or more sensing measurement parameter values based on performing the sensing operation, where the transmitted indication of the one or more sensing measurement parameter values includes an indication of the estimated one or more sensing measurement parameter values transmitted on a set of resources indicated by the configuration.

Some examples of the method, apparatuses, and non-transitory computer-readable medium described herein may further include operations, features, means, or instructions for obtaining sensing data according to the configuration and based on performing the sensing operation, where the transmitted indication of the one or more sensing measurement parameter values include the sensing data.

In some examples of the method, apparatuses, and non-transitory computer-readable medium described herein, the configuration identifies for the wireless device to report the one or more sensing measurement parameter values as at least a part of a periodic radio resource management (RRM) measurement report.

Some examples of the method, apparatuses, and non-transitory computer-readable medium described herein may further include operations, features, means, or instructions for determining a performance metric satisfies a threshold based on the configuration, where the sensing operation may be performed based on determining the performance metric satisfies the threshold.

In some examples of the method, apparatuses, and non-transitory computer-readable medium described herein, the performance metric includes a reference signal received power (RSRP), a reference signal received quality (RSRQ), a signal to interference plus noise ratio (SINR), or any combination thereof.

Some examples of the method, apparatuses, and non-transitory computer-readable medium described herein may further include operations, features, means, or instructions for performing the sensing operation based on detecting an event, storing the one or more sensing measurement parameter values based on performing the sensing operation, and receiving, from the base station, an indication to transmit the stored one or more sensing measurement parameter values, the indication of the stored one or more sensing measurement parameter values transmitted to the base station at least in part in response to receiving the indication to transmit the stored one or more sensing measurement parameter values.

In some examples of the method, apparatuses, and non-transitory computer-readable medium described herein, the wireless device may be operating in an idle mode or an inactive mode.

In some examples of the method, apparatuses, and non-transitory computer-readable medium described herein, the event includes the wireless device entering an out-of-coverage area.

Some examples of the method, apparatuses, and non-transitory computer-readable medium described herein may further include operations, features, means, or instructions for performing the sensing operation based on one or more machine learning capabilities at the wireless device.

In some examples of the method, apparatuses, and non-transitory computer-readable medium described herein, the sensing operation may be performed using millimeter wave (mmWave) frequencies.

In some examples of the method, apparatuses, and non-transitory computer-readable medium described herein, the wireless device includes a user equipment or a distributed unit (DU) of an integrated access and backhaul (IAB) node.

### BRIEF DESCRIPTION OF THE DRAWINGS

FIGS. 1 and 2 each illustrate an example of a wireless communications system that supports techniques for adding surrounding information in minimization of drive test (MDT) reporting in accordance with aspects of the present disclosure.

FIGS. 3 and 4 each illustrate an example of a process flow that supports techniques for adding surrounding information in MDT reporting in accordance with aspects of the present disclosure.

FIGS. 5 and 6 show block diagrams of devices that support techniques for adding surrounding information in MDT reporting in accordance with aspects of the present disclosure.

FIG. 7 shows a block diagram of a communications manager that supports techniques for adding surrounding information in MDT reporting in accordance with aspects of the present disclosure.

FIG. 8 shows a diagram of a system including a device that supports techniques for adding surrounding information in MDT reporting in accordance with aspects of the present disclosure.

FIGS. 9 and 10 show flowcharts illustrating methods that support techniques for adding surrounding information in MDT reporting in accordance with aspects of the present disclosure.

### DETAILED DESCRIPTION

In some wireless communications systems, a wireless communications network may collect information to determine the network performance at various locations throughout the network coverage area. For example, one or more network entities, such as a base station, may configure wireless communication devices operating in the network to report performance and location information to the network. Such wireless communications devices (e.g., wireless devices) may include a user equipment (UE), a station, an access point, an integrated access and backhaul (IAB) node, or a distributed unit (DU) of an IAB node. The network may use the reported information to train or develop machine learning models that may be used to enhance network performance (e.g., update one or more aspects of the network configuration in at least some locations, such as through adjusting one or more parameter values or other settings). In some cases, such techniques may include self-organizing network (SON) mechanisms or minimization of drive test (MDT) mechanisms. In some instances, to support the SON mechanisms, the MDT mechanism, or other similar mechanisms, the wireless devices may report information, such as higher layer data, to the base station or other network entities. In some examples, however, information provided to the network by a wireless device may not account for surroundings of the wireless device.

For example, the wireless device may report a decrease (e.g., or drop) in network coverage at a location, but without information regarding the surrounds of the wireless device, the network may not determine whether service in the location may be improved. That is, the network may not determine whether techniques for enhancing network performance, such as increasing cell power or deploying additional cells in the location, will increase coverage in the location. For example, the network may not know whether the wireless device is located in an elevator and service in that location may not be improved by techniques for enhancing network performance (e.g., or performing such techniques would not be an efficient use of network resources) or whether the wireless device is in an open space and the network may improve coverage in the location by increasing the cell power or deploying additional cells in the location. Therefore, it may be desirable for a wireless device to report surrounding information (e.g., information regarding the surrounding environment of the wireless device) to the network.

In some examples, a wireless device may be configured to sense the surrounding environment and estimate the location, orientation, or dimensions of nearby reflectors (e.g., walls, furniture, human body parts). The wireless device may perform sensing operations (e.g., Wi-Fi sensing operations or New Radio (NR) sensing operations) autonomously or according to a configuration by the network. For example, the wireless device may be configured to perform a sensing operation periodically or based on a condition being satisfied, such as service (e.g., network coverage) failing to satisfy a threshold. In some examples, the wireless device may report sensing information (e.g., collected via a sensing operation) to the network. The sensing information may include data collected during the sensing operation or surrounding information extracted from the collected sensing data.

In other examples, the wireless device may perform the sensing operations autonomously. For example, the wireless device may perform a sensing operation in response to entering an out-of-coverage area. In such an example, the wireless device may store data collected from the sensing operation for a duration of time (e.g., 48 hours). In some examples, the network may request the stored sensing data over the duration of time. In some examples, an event (e.g., a radio link failure (RLF) or a connection establishment failure (CEF)) may trigger the wireless device to perform a sensing operation. In such examples, the wireless device may include the sensing information as part of a report to the network. For example, the wireless device may send (e.g., transmit) the report to the network during a connection establishment procedure. In some examples, information regarding the surroundings of a wireless device may aid techniques for enhancing network performance and improve network deployments.

Aspects of the disclosure are initially described in the context of wireless communications systems. Aspects of the disclosure are further illustrated by and described with reference to process flows, apparatus diagrams, system diagrams, and flowcharts that relate to techniques for adding surrounding information in MDT reporting.

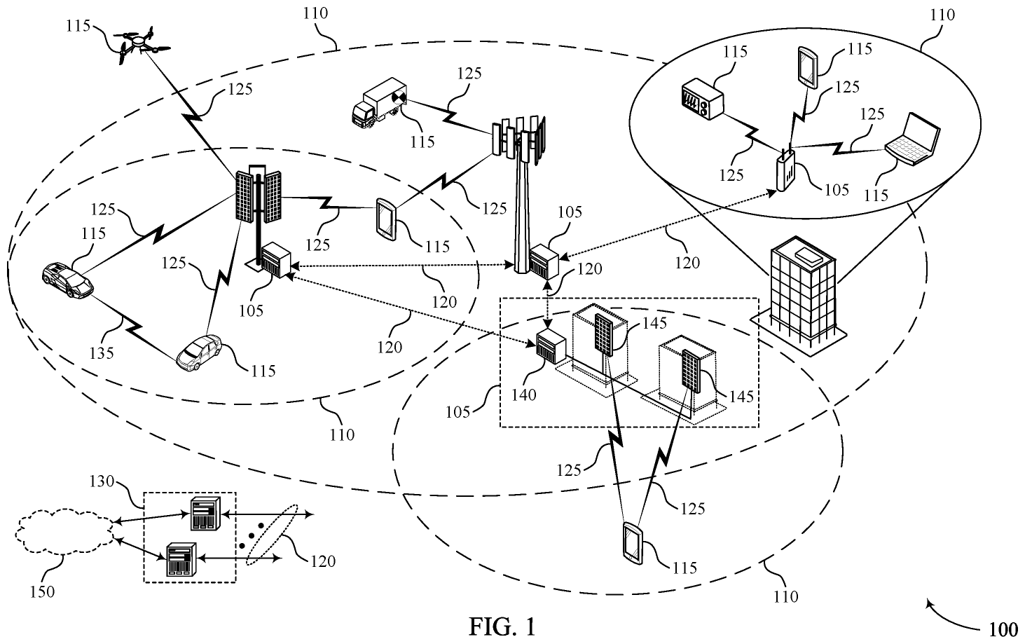

FIG. 1 illustrates an example of a wireless communications system 100 that supports techniques for adding surrounding information in MDT reporting in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support techniques for adding surrounding information in MDT reporting. For example, a wireless device (e.g., a UE 115 or another wireless device such as an IAB node) may receive an indication of a configuration for sensing measurement parameter reporting from a base station 105. The sensing measurement parameter reporting may be for a sensing operation, such as a Wi-Fi sensing operation or an NR sensing operation. The wireless device may perform the sensing operation based on the configuration and transmit an indication of a measurement parameter value to the base station 105. The sensing measurement parameter value may be associated with a location of the wireless device. In some examples, the wireless device may transmit the indication of the sensing measurement parameter value based on performing the sensing operation.

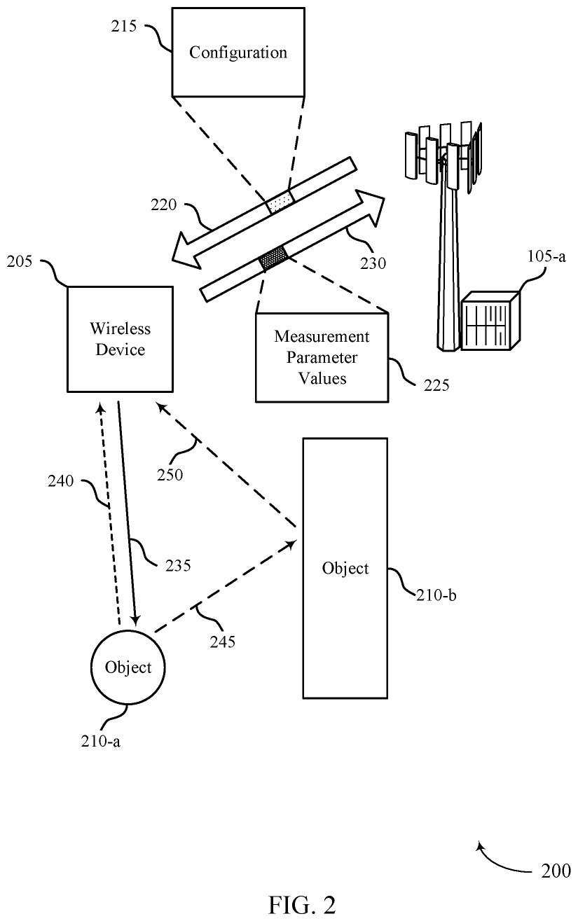

FIG. 2 illustrates an example of a wireless communications system 200 that supports techniques for adding surrounding information in MDT reporting in accordance with aspects of the present disclosure. In some examples, the wireless communications system 200 may implement aspects of the wireless communications system 100. For instance, the wireless communications system 200 may include a wireless device 205 which may be an example of an IAB node (e.g., a DU of an IAB node), a station (e.g., or an access point), or a UE described with reference to FIG. 1. Additionally or alternatively, the wireless communications system 200 may include a base station 105-a which may be an example of a base station 105 described with reference to FIG. 1. In some examples, the wireless device 205 and the base station 105-a may communicate via one or more communication links (e.g., a communication link 220 and a communication link 230). In some examples, the communication link 220 may be an example of a downlink and the communication link 230 may be an example of an uplink. In other examples, the communication link 220 and the communication link 230 may each be examples of backhaul links (e.g., wireless backhaul links).

The wireless communications system 200 may support one or more sensing operations for adding surrounding information in MDT reporting. In some examples, wireless device 205 may be configured with one or more parameters for reporting surrounding information (e.g., obtained via a sensing operation) to the network (e.g., the base station 105-a). For example, the wireless device 205 may receive an indication of a configuration (e.g., a configuration 215) for reporting surrounding information (e.g., a configuration for sensing measurement parameter reporting) from the base station 105-a (e.g., via the communication link 220). In some examples, the wireless device 205 may perform the sensing operation based on the configuration. Additionally or alternatively, the wireless device 205 may perform the sensing operation autonomously (e.g., may be triggered to perform the sensing operation based on an event) and report the surrounding information (e.g., interpreted parameters) through an event report. In some examples, whether the wireless device 205 performs the sensing operation based on a configuration or an event may depend on capabilities of the wireless device 205. That is, the wireless device 205 may perform a sensing operation based on capabilities of the wireless device 205.

In some examples, the wireless device 205 may perform the sensing operation to determine (e.g., sense) the surrounding environment and estimate the location, orientation, and dimensions of nearby reflectors (e.g., walls, furniture, human body parts, and the like). In some examples, reflectors may be referred to as objects. That is, by using (e.g., performing) the sensing operation, surrounding information may be made available to the wireless device 205 at a given instance of time. In some examples, the wireless device 205 may send out (e.g., emit) a signal and sense (e.g., detect) portions of the signal reflected back to the wireless device 205. The wireless device 205 may use the detected signal to estimate an object (e.g., a pose of a human or an animal) or track an object (e.g., a human walking or an animal moving, such as a pet). In other words, the wireless device 205 may sense the surrounding environment to identify surrounding objects and determine how the surrounding objects are moving. Additionally or alternatively, the sensing operation may be performed using a camera. That is, the surrounding info may be obtained using information captured via a camera. Additionally or alternatively, the sensing operation may be performed using infrared sensors.

In some examples, the wireless device 205 may emit a sensing signal 235 (e.g., an emitted waveform). As shown, the sensing signal 235 may collide with one or more objects (e.g., an object 210-a or an object 210-b), such that the sensing signal 235 (e.g., or portions of the sensing signal 235) may be redirected (e.g., reflected, scattered, refracted, or diffracted). For example, at least a portion of the sensing signal 235 may reflect off of the object 210-a back towards the wireless device 205. As shown, the portion of the sensing signal 235 reflected back towards the wireless device 205 may include a reflected signal 240. In other examples, at least a portion of the sensing signal 235 may reflect off of the object 210-a towards another object (e.g., an object 210-b). For example, the portion of the sensing signal 235 reflected off of the object 210-a towards the object 210-b may include a reflected signal 245. Additionally or alternatively, at least a portion of the reflected signal 245 may reflect off of the object 210-b towards the wireless device 205. For example, the portion of the reflected signal 245 reflected off of the object 210-b may include a reflected signal 250. The wireless device 205 may receive (e.g., detect) the reflected signal 240 and the reflected signal 250. In some examples, the reflected signal 250 may have a reduced received signal strength indicator (RSSI) relative to the reflected signal 240.

The wireless device 205 may analyze the reflected signal 240 and the reflected signal 250 (e.g., the reflected waveforms) to estimate the surrounding environment of the wireless device 205. In some examples, the wireless device 205 may be obstructed from the object 210-a or the object 210-b by another object 210 (not shown). That is, the wireless device 205 may use the sensing operation to sense (e.g., or detect) the line-of-sight (LOS) environment of the wireless device 205 and the non-line-of-sight (NLOS) environment of the wireless device 205. As such, the sensing operation may be used to generate a sensing map (e.g., of the surrounding environment including LOS and NLOS objects). In some examples, a sensing map may include a range Doppler map, an antenna-specific range Doppler map, an angle angular velocity map, a velocity range map, or a three dimensional (3D) map of the environment (e.g., a 3D indoor map), among other examples.

Additionally or alternatively, the sensing operation may be used to track one or more objects, such as the object 210-a. In some examples, the tracking of objects may include health monitoring (e.g., heartbeat detection, respiration rate monitoring), gesture recognition (e.g., human activity recognition, keystroke detection, or sign language recognition), contextual information acquisition (e.g., object location detection, object tracking, object direction finding, object range estimation, or object velocity estimation), automotive sensing (e.g., smart cruise control or collision avoidance), among other examples. In some examples, the tracking of objects may include environment scanning for SON mechanisms, indoor factory environments, and the like. In some examples, sensing signals (e.g., the sensing signal 235) may include or be based on a communication waveform (e.g., a downlink communication signal, an uplink communication signal, a millimeter wave (mmWave) communication signal, FR2, FR2x, or FR4).

In some examples, the sensing operation may include a Wi-Fi sensing operation or a NR sensing operation. That is, the wireless device 205 may perform sensing operations using a number of frequencies (e.g., sub-6 GHz frequencies or mmWave frequencies). In some examples, NR sensing may refer to Wi-Fi sensing operations performed using mmWave frequencies, such as 60 GHz. That is, NR sensing may refer to a Wi-Fi sensing protocol performed using the NR spectrum. A number of applications may be designed for (e.g., to be used with) a sensing operation, such as the Wi-Fi sensing operation or the NR sensing operation. For example, the wireless device 205 (e.g., or a chipset of the wireless device 205) may support channel capture using the sensing operation (e.g., Wi-Fi sensing). Channel capture may refer to the wireless device 205 capturing (e.g., measuring or determining) channel state information (CSI) via the sensing operation (e.g., from data collected via the sensing operation).

The sensing operation may be based on the wireless device 205 (e.g., may be UE based sensing) or assisted by the base station 105-a (e.g., may be UE assisted sensing). Additionally or alternatively, the sensing operation may be sidelink sensing, among other examples. In some examples of UE assisted sensing, one or more aspects of the sensing operation may be configured by the network (e.g., via the base station 105-a). For example, the network may configure resources for the sensing signal (e.g., the sensing signal 235). Additionally or alternatively, the network may configure the sensing operation such that sensing (e.g., of the sensing signal 235) is performed via monostatic sensing or bistatic sensing. Bistatic sensing may refer to sensing in which a first device transmits the sensing signal and a second device scans the sensing signal (e.g., senses the reflect portions of the sensing signal) and estimates the surrounding environment. Monostatic sensing may refer to sensing in which sensing signals are transmitted and sensed by a single device (e.g., the wireless device 205). In some examples of monostatic sensing, the wireless device may report the information (e.g., the captured CSI, also referred to as data) collected via the sensing operation to the network. In such examples, the network may use the captured CSI to estimate the surroundings of the wireless device 205. For example, the wireless device 205 may generate the sensing map (e.g., the 3D map) or make determinations about objects or people located in the surrounding environment of the wireless device 205. In other examples, the wireless device 205 may estimate the surrounding information (e.g., from the captured CSI) and report the surrounding information or the captured CSI to the network.

In some examples of UE based sensing, the sensing operation may be independent of the network. For example, the wireless device 205 may perform the sensing operation and estimate the sensing measurement parameters (e.g., the surrounding information) from the captured CSI. In such an example, the wireless device 205 may report the sensing measurement parameters (e.g., the sensing measurement parameter values) and may not report the data (e.g., the captured CSI) collected via the sensing operation.

The wireless device 205 may report the sensing measurement parameter values to the network (e.g., the base station 105-a) via an indication. For example, the wireless device 205 may transmit an indication of the sensing measurement parameter values (e.g., the measurement parameter values 225) to the base station 105-a via the communication link 230. In some examples, the wireless device 205 may report the sensing measurement parameter values (e.g., or the sensing signal measurements) in an MDT report to aid the network with techniques for enhancing network performance.

For example, the wireless device 205 may report the sensing measurement parameter values with (e.g., in addition to) measurement information (e.g., performance and location information) included in an MDT report. In some examples, the network may use MDT reporting (e.g., or MDT mechanisms) to collect the measurement information from a wireless device (e.g., the wireless device 205) to aid techniques for enhancing network performance. In some examples, MDT mechanisms may include logged MDT and immediate MDT. Logged MDT may refer to MDT mechanisms in which the wireless device logs information (e.g., measurements, locations, and sensor information collected via a sensing operation) and sends the information to the network when requested (e.g., by the network). For example, the wireless device may use logged MDT to store information (e.g., the sensing measurement parameter values) collected via one or more sensing operations for a duration of time (e.g., 48 hours) to be requested from the network at a given instance of time (e.g., within the 48 hours).

In some examples of logged MDT, the wireless device 205 may perform the sensing operation while in an active mode (e.g., an active state) or other power saving modes (e.g., an idle state or an inactive state). That is, the wireless device 205 may perform the sensing operation such that data may be stored for (e.g., during or in response to) an event, such as an out-of-coverage event or another event associated with reduced cell quality. For example, if an event is detected, the wireless device 205 may perform the sensing operation (e.g., a Wi-Fi sensing operation or an NR sensing operation), extract the surrounding information (e.g., from captured CSI), and store the surrounding information (e.g., with a time stamp). In some examples, if the network requests (e.g., via signals transmitted from the base station 105-a) the MDT information, the wireless device 205 may transmit the stored (e.g., logged) surrounding information to the base station 105-a. In such examples, the network may process the surrounding information to determine one or more causes for the triggering event.

Immediate MDT may refer to MDT mechanisms in which the wireless device sends (e.g., reports) the information (e.g., measurements, locations, and sensor information) after (e.g., in response to or subsequent to) the information is collected via the sensing operation. In some examples, the UE may perform immediate MDT while in an active mode (e.g., a connected mode). In some examples of immediate MDT, the measurements (e.g., the sensing measurement parameter values) collected via the sensing operation may be sent in a radio resource control (RRC) message. For example, the wireless device 205 may transmit an indication of the sensing parameter values as part of a radio resource management (RRM) measurement report. In some examples, such measurement reporting (e.g., RRM reporting) may be triggered by an event (e.g., an A2 event or an A5 event) or may be reported periodically (e.g., for periodic measurements). In some examples, an event (e.g., an A2 event or an A5 event) may refer to the signal quality (e.g., service) of a cell (e.g., a serving cell, a neighboring cell, a primary cell, or a secondary cell of a primary cell group, among other examples) failing to satisfy a threshold. For example, a measured performance metric (e.g., reference signal received power (RSRP), reference signal received quality (RSRQ), signal-to-interference-plus-noise ratio (SINR), or any combination thereof) may fail to satisfy a threshold (e.g., a configured or dynamically updated threshold).

For example, if the wireless device 205 is triggered to perform RRM measurements (e.g., by the detection of an event), the wireless device 205 may also perform the sensing operation (e.g., a Wi-Fi sensing operation or an NR sensing operation) and report the extracted (e.g., determined) surrounding information (e.g., the sensing measurement parameter values). In some examples, the wireless device 205 may report the captured CSI and the network may make interpretations (e.g., regarding environmental factors such as obstacles) based on the captured CSI. For example, the network may make interpretations regarding obstacles in the environment of the wireless device 205 based on the signal (e.g., a reflected signal) being detected by the wireless device 205 on various cells.

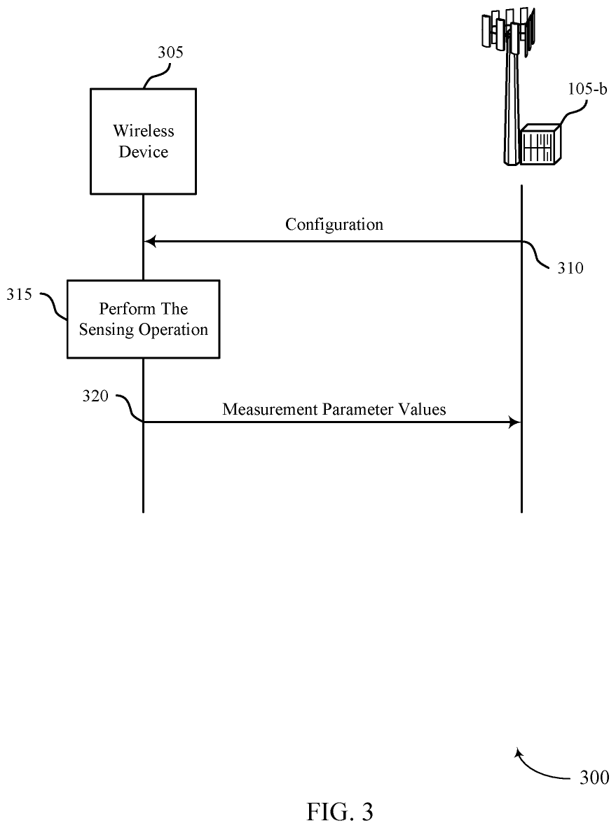

FIG. 3 illustrates an example of a process flow 300 that supports techniques for adding surrounding information in MDT reporting in accordance with aspects of the present disclosure. The process flow 300 may implement or be implemented by one or more aspects of the present disclosure. For example, the process flow 300 may be implemented by a wireless device 305 or a base station 105-b, which may be examples of the corresponding devices described with reference to FIG. 2. In the example of FIG. 3, the wireless device 305 may be a UE, a station (e.g., or an access point), or an IAB node (e.g., a DU of an IAB node).

In some examples, the base station 105-b and the wireless device 305 may implement the process flow 300 to promote network efficiencies by supporting techniques for adding surrounding information in MDT reporting. The process flow 300 may also be implemented by the base station 105-b and the wireless device 305 to promote high reliability and low latency operations, among other benefits. In the following description of the process flow 300, the operations between the wireless device 305 and the base station 105-b may be transmitted in a different order than the example order shown. Additionally or alternatively, the operations performed by the wireless device 305 and the base station 105-b may be performed in different orders or at different times. Some operations may also be omitted.

At 310, the wireless device 305 may receive an indication of a configuration for sensing measurement parameter (e.g., surrounding information) reporting for a sensing operation from the base station 105-b. That is, the indication received at 310 may configure the wireless device 305 to report surrounding information collected via a sensing operation performed by the wireless device 305. For example, at 315, the wireless device 305 may perform the sensing operation based on the configuration for the sensing parameter reporting. In some examples, the wireless device 305 may perform the sensing operation with or without assistance from another device (e.g., an access point or a base station). For example, a station may operate independent of an access point and, as such, may perform the sensing operation (e.g., a Wi-Fi sensing operation) without assistance from the access point. In other examples, a UE may perform the sensing operation (e.g., an NR sensing operation) with assistance from the network (e.g., may perform UE-assisted sensing via assistance from a base station) or without assistance from the network (e.g., may perform UE-based sensing).

In some examples, the sensing operation may be used to capture channel information (e.g., CSI) which may provide the wireless device 305 with surrounding information (e.g., information regarding the environment surrounding the wireless device 305). The channel information obtained (e.g., captured) from sensing operation may be reported to or requested by the network. In some examples, the surrounding information (e.g., sensing measurement parameter values) may be added in an MDT report, for example in an out-of-service scenario, an RLF scenario, or a secondary cell group (SCG) failure scenario to be used by the network for enhancing network performance. For example, the network may configure the wireless device 305 to report surrounding information in an MDT report for mmWave scenarios in which the surroundings of the wireless device 305 (e.g., or changes in the surroundings, such as obstacles) may impact the performance of the wireless device 305.

In some examples, the wireless device 305 may interpret (e.g., determine) the surrounding information from the captured CSI. That is, the surrounding information (e.g., sensing measurement parameter values) may be based on CSI determined (e.g., captured) by the wireless device 305 during the sensing operation. In some examples, the accuracy of the determined surrounding information may depend on one or more capabilities of the wireless device 305 (e.g., UE capabilities, such as machine learning capabilities). In some examples, the surrounding information (for example, which may be included in the MDT log obtained through the sensing operation) may include space information (e.g., UE space information, such as whether the surroundings are open or enclosed), dimensions of an enclosed space (e.g., width, breadth, and height), type of enclosed space (e.g., car, room, auditorium, or the like), people or object information (e.g., object type, distance, density, motion), type of material surrounding the wireless device 305, or a motion state of the wireless device 305 (e.g., at what speed the UE may be travelling).

At 320, the wireless device 305 may transmit an indication of one or more sensing measurement parameter values associated with a location of the wireless device 305 (e.g., surrounding information) to the base station 105-b. The wireless device 305 may transmit the indication based on performing the sensing operation. In some examples, the wireless device 305 may transmit the indication of the surrounding information as part of a SON report. For example, (e.g., upon detecting an RLF, an SCG failure, or a CEF) the wireless device may perform the sensing operation and transmit the surrounding information in the SON report. In some examples (e.g., for sensing operations with mmWave frequencies), obstacles may degrade the performance of wireless communications at the wireless device 305 and transmitting the surrounding information in a SON report may aid the network in determining whether a failure (e.g., the RLF, the SCG failure, or the CEF) may be due to objects attenuating the signal.

In some other examples, the wireless device 305 may transmit the indication of the surrounding information as part of an MDT report. That is, the wireless device 305 may include the surrounding information (e.g., sensing measurement parameter values) in an MDT report. For example, the wireless device may report the surrounding information via information elements (IEs) in an RRC message or as application layer information. In other examples, the wireless device 305 may indicate the surrounding information as part of a quality of experience report. For example, the wireless device 305 may report application information (e.g., application specific information) to the network. In some examples, the wireless device may transmit application positioning information (e.g., from applications or from the sensing operation) to enhance the quality of experience report.

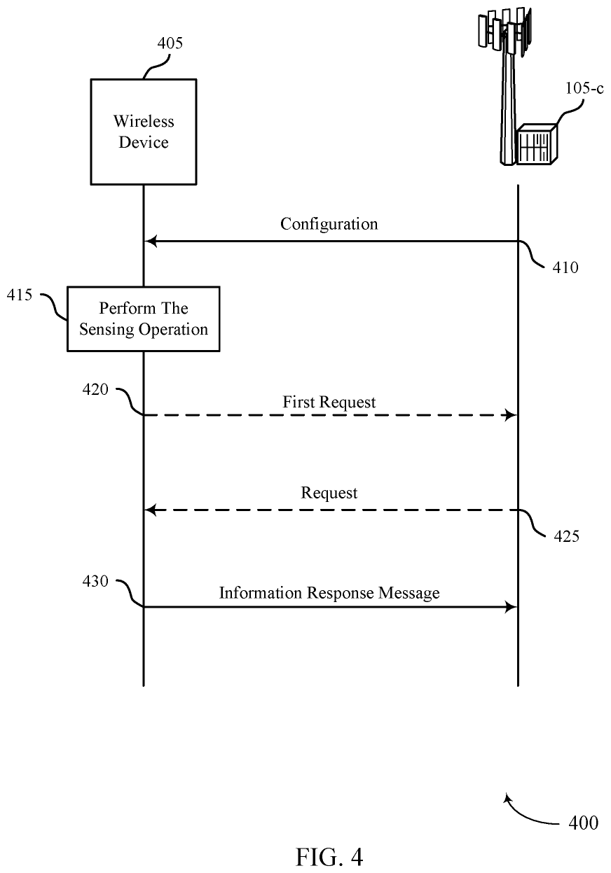

FIG. 4 illustrates an example of a process flow 400 that supports techniques for adding surrounding information in MDT reporting in accordance with aspects of the present disclosure. The process flow 400 may implement or be implemented by one or more aspects of the present disclosure. For example, the process flow 400 may be implemented by a wireless device 405 or a base station 105-c, which may be examples of the corresponding devices described with reference to FIGS. 2 and 3. In the example of FIG. 4, the wireless device 405 may be a UE, a station (e.g., or an access point or a base station, such as a NodeB), or an IAB node (e.g., a DU of an IAB node).

In some examples, the base station 105-c and the wireless device 405 may implement the process flow 400 to promote network efficiencies by supporting techniques for adding surrounding information in MDT reporting. The process flow 400 may also be implemented by the base station 105-c and the wireless device 405 to promote high reliability and low latency operations, among other benefits. In the following description of the process flow 400, the operations between the wireless device 405 and the base station 105-c may be transmitted in a different order than the example order shown. Additionally or alternatively, the operations performed by the wireless device 405 and the base station 105-c may be performed in different orders or at different times. Some operations may also be omitted.

At 410, the wireless device 405 may receive an indication of a configuration for sensing measurement parameter reporting for a sensing operation to the base station 105-c. At 415, the wireless device 405 may perform the sensing operation based on the configuration sensing measurement parameter reporting. In some examples, at 420, the wireless device 405 may transmit a first request to report one or more sensing operation measurement parameter values (e.g., surrounding information) to the base station 105-c. The wireless device 405 may transmit the first request to the base station 105-c in response to an event. For example, the wireless device may transmit the first request in response to a RLF, a SCG failure, or a CEF.

In some examples, at 425, the wireless device 405 may receive a request from the base station 105-c to report the one or more sensing measurement parameter values. The request from the base station 105-c may be received in response to transmitting the first request. At 430, the wireless device 405 may transmit an indication of the one or more sensing measurement parameter values (e.g., surrounding information) associated with a location of the wireless device 405 to the base station 105-c. That is, the wireless device 405 may report surrounding information to the network.

In some examples, the surrounding information may indicate whether the wireless device 405 is in an open or enclosed space. For example, the sensing operation (e.g., a Wi-Fi sensing operation or an NR sensing operation) may provide an indication of an enclosed space surrounding the wireless device 405 and, in some examples, beyond the enclosed space. For example, the sensing operation may be used to generate a 3D map of the surround environment. Additionally or alternatively, the surrounding information may indicate dimensions of the enclosed space (e.g., for a car or a room). For example, if the wireless device 405 is located in an enclosed space, the sensing operation may enable the wireless device 405 (e.g., or the network) to determine the dimensions of the enclosed space. In some examples, such information may enable the wireless device 405 (e.g., or the network) to determine whether the wireless device 405 may be located in a car, or a room, among other examples.

In some examples, the surrounding information may indicate the presence of nearby people or objects. For example, the sensing operation may be used to spot (e.g., detect) nearby people or objects which may aid in the estimation of the environment (e.g., surroundings) of the wireless device 405. In some examples, details regarding the number of people (e.g., or objects) may enable the network to correlate the MDT information (e.g., performance and location information) of the wireless device 405 (e.g., reported by the wireless device 405) with information reported by other wireless devices 405, not shown, at (e.g., approximately) a same instance of time. For example, the presence of an object may aid the network in estimating the density of the surroundings and, as such, estimate an attenuation factor (e.g., an extent to which the sensing signal is attenuated by the surroundings). In some examples (e.g., for sensing operations with mmWave frequencies), details (e.g., characteristics) of objects (e.g., obstacles) located in a direction of a serving cell (e.g., serving the wireless device 405) may be beneficial for improving network coverage in the location of the wireless device 405.

In some examples, the surrounding information may indicate attributes (e.g., characteristics) of the environment surrounding the wireless device 405. For example, the sensing operation may capture details of streets, stores, milestones, and the like, through information boards (e.g., billboards or other signs). In some examples, characteristics of the environment surrounding the wireless device 405 may act as secondary location information to validate location information obtained through other mechanisms, such as global positioning systems (GPS) or Wi-Fi, among other examples.

In some examples, the surrounding information may include information regarding the environment beyond the enclosed space (e.g., if there are multiple enclosed spaces surrounding the enclosed space in which the wireless device 405 is present). For example, the sensing operation (e.g., a Wi-Fi sensing operation) may be used to sense beyond walls (e.g., or other obstacles) to detect NLOS objects or other types of surrounding information discussed above.

In some examples, the surrounding information may indicate a material surrounding the wireless device 405. For example, the material surrounding the wireless device 405 may influence (e.g., impact) the signal (e.g., the sensing signal or other signals transmitted to or from the wireless device 405) attenuation. Thus, information regarding the material surrounding the wireless device 405 may aid the network in improving network coverage in the location of the wireless device 405.

In some examples, the surrounding information may indicate motion history (e.g., past motion) of the wireless device 405. For example, the sensing operation (e.g., a Wi-Fi sensing operation) may aid in determining the motion of the wireless device 405 based on changes in the surroundings of the wireless device 305. In some examples, information regarding changes in the surroundings of the wireless device 405 may be determined from previous sensing operations (e.g., taken from past sampling). In some examples, such information may be reported in addition to (e.g., or used to validate) other MDT motion information, such as sensor data, GPS data, or a network configured mobility state.

In some examples, transmitting the indication of the one or more sensing measurement parameter values may include transmitting an information response message. For example, the wireless device 405 may transmit the information response message in response to receiving the request to report the one or more sensing measurement parameter values. In some examples, the wireless device 405 may transmit the indication (e.g., or the information response message) based on performing the sensing operation.

In some examples, the wireless device 405 may perform the sensing operation in response to experiencing an out-of-service-event and send (e.g., report) the surrounding information to the network. In such examples, the network may use the reported surrounding information to determine whether the wireless device 405 may expect to experience an out-of-service event at the location (e.g., if the wireless device 405 is determined to be located in an elevator or a tunnel and the out-of-service event is expected) or whether the network may perform techniques for enhancing network coverage, such as deploy an additional cells (e.g., if the wireless device 405 is determined to be in an open space and the out-of-service event is due to a hole in the network coverage).

In some examples, if the wireless device 405 sends (e.g., reports) information that multiple objects (e.g., people with wireless devices) are in the surroundings, the network may account for the multiple objects and determine whether multiple out-of-service events or RLFs have been reported in (e.g., around) the same location. In some examples, if the network determines no other wireless devices reported an out-of-service event, the network may determine the out-of-service event is due to a radio frequency (e.g., a radio frequency sub-band) used for communications with the wireless device 405 and determine to use another (e.g., different) sub-band.

In some examples, the wireless device 405 may report a RLF due to a high block error ratio (BLER) or reduced resource grants allocated to the wireless device 405. In such examples the network may use the surrounding info to determine that the wireless device 405 is located in an auditorium with a number of other wireless devices 405. For example, the network may determine to increase the capacity of the network in that region by deploying additional spectrum (e.g., additional frequencies), additional nodes, or additional small cells. In some examples, the network may also use the surrounding information to determine that the report RLF occurred at a particular periodicity (e.g., a day of the week) and may perform techniques for enhancing network coverage at the determined periodicity.

In some examples, the network may determine that the performance of the wireless device 405 has degraded (e.g., the network may determine RLFs, or a high BLER) and may use the surrounding information to determine whether the wireless device 405 is a mobile wireless device (e.g., a vehicle). In such an example, if the network determines that the wireless device is a vehicle (e.g., or another mobile device) the network may determine that additional reference signals (e.g., demodulation reference signals (DMRSs)) may be scheduled to improve decoding at the wireless device 405.

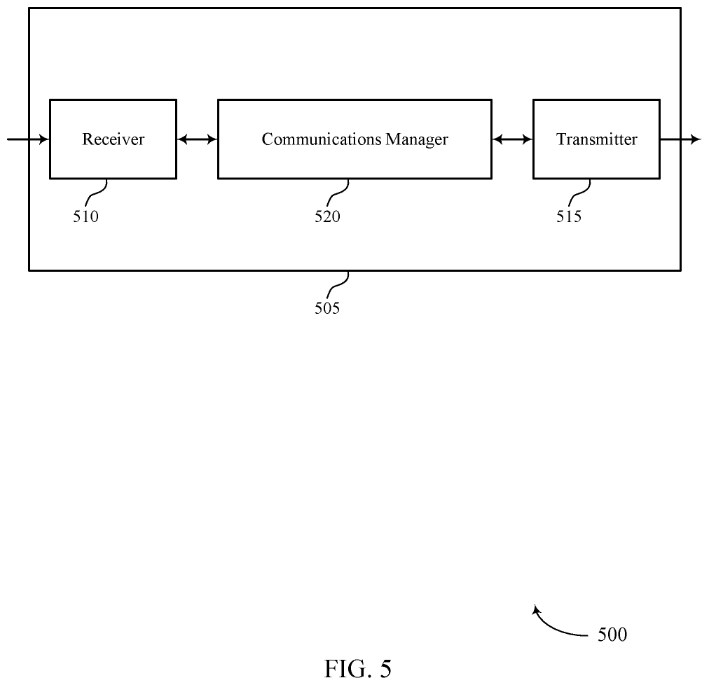

FIG. 5 shows a block diagram 500 of a device 505 that supports techniques for adding surrounding information in MDT reporting in accordance with aspects of the present disclosure. The device 505 may be an example of aspects of a device as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for adding surrounding information in MDT reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for adding surrounding information in MDT reporting). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of adding surrounding information in MDT reporting as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a wireless device (e.g., the device 505) in accordance with examples as disclosed herein. For example, the communications manager 520 may be configured as or otherwise support a means for receiving, from a base station, an indication of a configuration for sensing measurement parameter reporting for a sensing operation. The communications manager 520 may be configured as or otherwise support a means for performing, by the wireless device, the sensing operation based on the configuration for the sensing measurement parameter reporting. The communications manager 520 may be configured as or otherwise support a means for transmitting, to the base station, an indication of one or more sensing measurement parameter values associated with a location of the wireless device based on performing the sensing operation.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for adding surrounding information in MDT reporting. For example, the device 505 may report sensing measurement parameter values based on sensing operations, as described herein, which may result in more efficient utilization of communication resources.

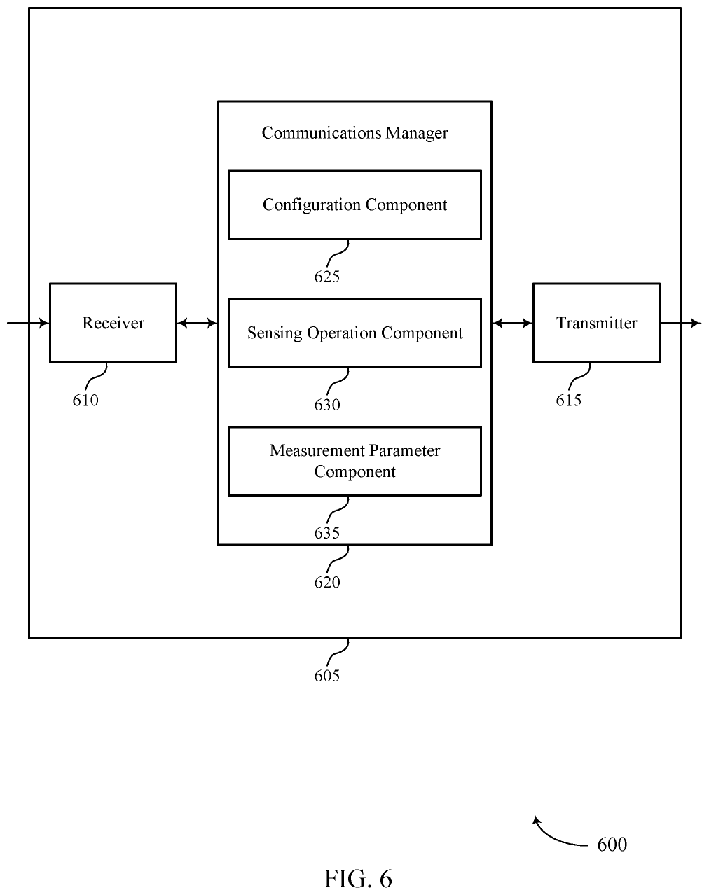

FIG. 6 shows a block diagram 600 of a device 605 that supports techniques for adding surrounding information in MDT reporting in accordance with aspects of the present disclosure. The device 605 may be an example of aspects of a device 505 or a device as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for adding surrounding information in MDT reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for adding surrounding information in MDT reporting). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of adding surrounding information in MDT reporting as described herein. For example, the communications manager 620 may include a configuration component 625, a sensing operation component 630, a measurement parameter component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a wireless device (e.g., the device 605) in accordance with examples as disclosed herein. The configuration component 625 may be configured as or otherwise support a means for receiving, from a base station, an indication of a configuration for sensing measurement parameter reporting for a sensing operation. The sensing operation component 630 may be configured as or otherwise support a means for performing, by the wireless device, the sensing operation based on the configuration for the sensing measurement parameter reporting. The measurement parameter component 635 may be configured as or otherwise support a means for transmitting, to the base station, an indication of one or more sensing measurement parameter values associated with a location of the wireless device based on performing the sensing operation.

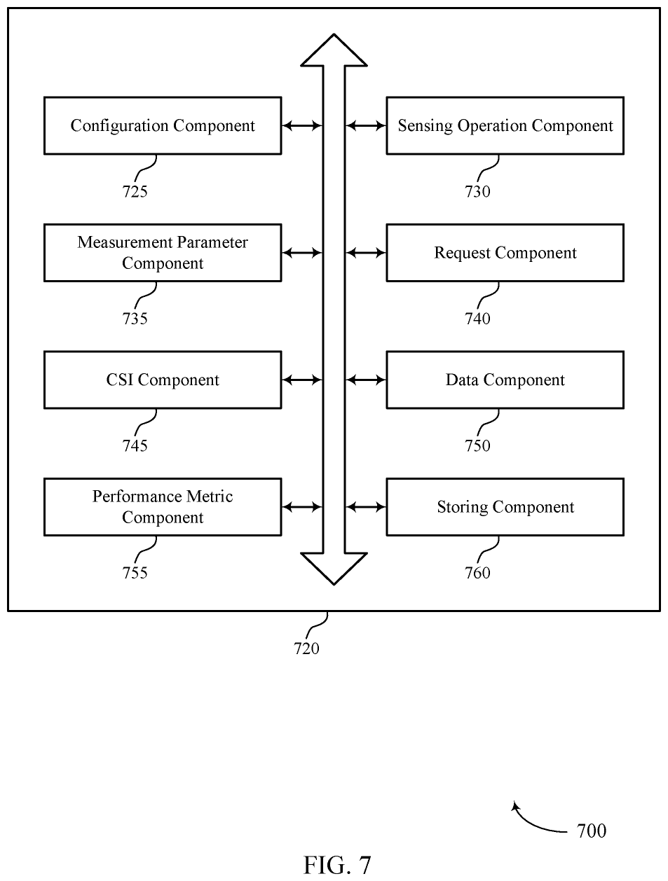

FIG. 7 shows a block diagram 700 of a communications manager 720 that supports techniques for adding surrounding information in MDT reporting in accordance with aspects of the present disclosure. The communications manager 720 may be an example of aspects of a communications manager 520, a communications manager 620, or both, as described herein. The communications manager 720, or various components thereof, may be an example of means for performing various aspects of adding surrounding information in MDT reporting as described herein. For example, the communications manager 720 may include a configuration component 725, a sensing operation component 730, a measurement parameter component 735, a request component 740, a CSI component 745, a data component 750, a performance metric component 755, a storing component 760, or any combination thereof. Each of these components may communicate, directly or indirectly, with one another (e.g., via one or more buses).

The communications manager 720 may support wireless communication at a wireless device (e.g., a UE, a station, or a DU of an IAB node) in accordance with examples as disclosed herein. The configuration component 725 may be configured as or otherwise support a means for receiving, from a base station, an indication of a configuration for sensing measurement parameter reporting for a sensing operation. The sensing operation component 730 may be configured as or otherwise support a means for performing, by the wireless device, the sensing operation based on the configuration for the sensing measurement parameter reporting. The measurement parameter component 735 may be configured as or otherwise support a means for transmitting, to the base station, an indication of one or more sensing measurement parameter values associated with a location of the wireless device based on performing the sensing operation.

In some examples, the request component 740 may be configured as or otherwise support a means for transmitting, to the base station, a first request to report the one or more sensing measurement parameter values responsive to an event. In some examples, the request component 740 may be configured as or otherwise support a means for receiving, responsive to the transmitted first request, a request from the base station for the wireless device to report the one or more sensing measurement parameter values, where transmitting the indication of the one or more sensing measurement parameter values includes transmitting an information response message responsive to receiving the request to report the one or more sensing measurement parameter values.

In some examples, the event includes a radio link failure, a secondary cell group failure, a connection establishment failure, or any combination thereof. In some examples, the information response message is transmitted via radio resource control signaling. In some examples, to support transmitting the indication of the one or more sensing measurement parameter values, the measurement parameter component 735 may be configured as or otherwise support a means for transmitting, to the base station, a report associated with a quality of experience.

In some examples, the CSI component 745 may be configured as or otherwise support a means for determining channel state information based on the sensing operation, where the indication of the one or more sensing measurement parameter values are based on the determined channel state information. In some examples, the one or more sensing measurement parameter values include one or more of UE space information, one or more enclosed space dimensions, an enclosed space type, people information, animal information, object information, material type information, or a UE motion state.

In some examples, the measurement parameter component 735 may be configured as or otherwise support a means for estimating the one or more sensing measurement parameter values based on performing the sensing operation, where the transmitted indication of the one or more sensing measurement parameter values includes an indication of the estimated one or more sensing measurement parameter values transmitted on a set of resources indicated by the configuration.

In some examples, the data component 750 may be configured as or otherwise support a means for obtaining sensing data according to the configuration and based on performing the sensing operation, where the transmitted indication of the one or more sensing measurement parameter values include the sensing data. In some examples, the configuration identifies for the wireless device to report the one or more sensing measurement parameter values as at least a part of a periodic radio resource management measurement report.

In some examples, the performance metric component 755 may be configured as or otherwise support a means for determining a performance metric satisfies a threshold based on the configuration, where the sensing operation is performed based on determining the performance metric satisfies the threshold. In some examples, the performance metric includes an RSRP, an RSRQ, a SINR, or any combination thereof.

In some examples, the sensing operation component 730 may be configured as or otherwise support a means for performing the sensing operation based on detecting an event. In some examples, the storing component 760 may be configured as or otherwise support a means for storing the one or more sensing measurement parameter values based on performing the sensing operation. In some examples, the measurement parameter component 735 may be configured as or otherwise support a means for receiving, from the base station, an indication to transmit the stored one or more sensing measurement parameter values, the indication of the stored one or more sensing measurement parameter values transmitted to the base station at least in part in response to receiving the indication to transmit the stored one or more sensing measurement parameter values. In some examples, the wireless device is operating in an idle mode or an inactive mode. In some examples, the event includes the wireless device entering an out-of-coverage area.

In some examples, the sensing operation component 730 may be configured as or otherwise support a means for performing the sensing operation based on one or more machine learning capabilities at the wireless device. In some examples, the sensing operation is performed using mmWave frequencies. In some examples, the wireless device includes a user equipment or a distributed unit of an integrated access and backhaul node.

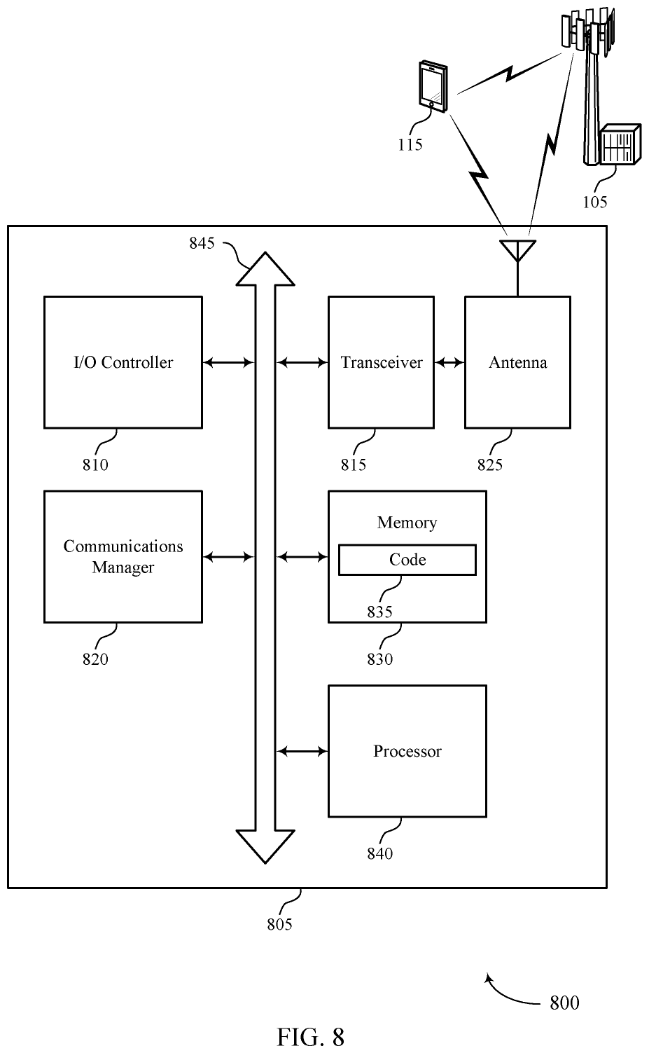

FIG. 8 shows a diagram of a system 800 including a device 805 that supports techniques for adding surrounding information in MDT reporting in accordance with aspects of the present disclosure. The device 805 may be an example of or include the components of a device 505, a device 605, or a wireless device as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for adding surrounding information in MDT reporting). For example, the device 805 or a component of the device 805 may include a processor 840 and memory 830 coupled with the processor 840, the processor 840 and memory 830 configured to perform various functions described herein.

The communications manager 820 may support wireless communication at a wireless device (e.g., the device 805) in accordance with examples as disclosed herein. For example, the communications manager 820 may be configured as or otherwise support a means for receiving, from a base station, an indication of a configuration for sensing measurement parameter reporting for a sensing operation. The communications manager 820 may be configured as or otherwise support a means for performing, by the wireless device, the sensing operation based on the configuration for the sensing measurement parameter reporting. The communications manager 820 may be configured as or otherwise support a means for transmitting, to the base station, an indication of one or more sensing measurement parameter values associated with a location of the wireless device based on performing the sensing operation.

By including or configuring the communications manager 820 in accordance with examples as described herein, the device 805 may support techniques for adding surrounding information in MDT reporting. For example, the device 805 may report sending measurement parameter values based on sensing operations, as described herein, which may result in improved user experience related to reduced processing, more efficient utilization of communication resources, improved coordination between devices, and improved utilization of processing capability, among other examples of advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of adding surrounding information in MDT reporting as described herein, or the processor 840 and the memory 830 may be otherwise configured to perform or support such operations.

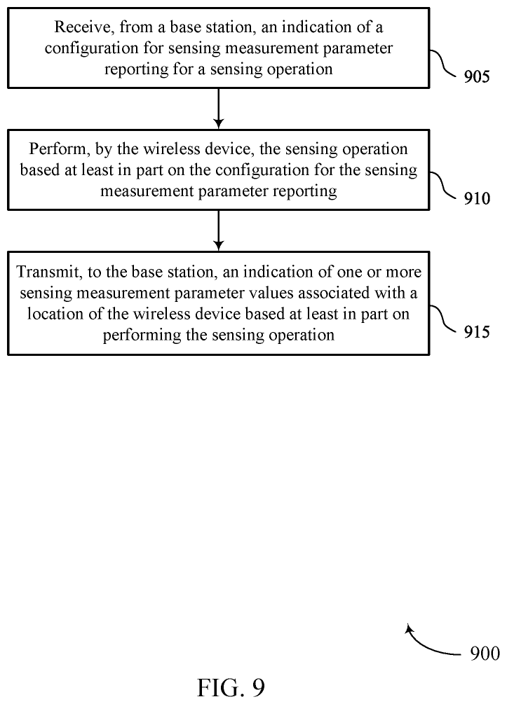

FIG. 9 shows a flowchart illustrating a method 900 that supports techniques for adding surrounding information in MDT reporting in accordance with aspects of the present disclosure. The operations of the method 900 may be implemented by a wireless device or its components as described herein. For example, the operations of the method 900 may be performed by a wireless device as described with reference to FIGS. 1 through 8. In some examples, a wireless device may execute a set of instructions to control the functional elements of the wireless device to perform the described functions. Additionally or alternatively, the wireless device may perform aspects of the described functions using special-purpose hardware.

At 905, the method may include receiving, from a base station, an indication of a configuration for sensing measurement parameter reporting for a sensing operation. The operations of 905 may be performed in accordance with examples as disclosed herein. In some examples, aspects of the operations of 905 may be performed by a configuration component 725 as described with reference to FIG. 7.

At 910, the method may include performing, by the wireless device, the sensing operation based on the configuration for the sensing measurement parameter reporting. The operations of 910 may be performed in accordance with examples as disclosed herein. In some examples, aspects of the operations of 910 may be performed by a sensing operation component 730 as described with reference to FIG. 7.

At 915, the method may include transmitting, to the base station, an indication of one or more sensing measurement parameter values associated with a location of the wireless device based on performing the sensing operation. The operations of 915 may be performed in accordance with examples as disclosed herein. In some examples, aspects of the operations of 915 may be performed by a measurement parameter component 735 as described with reference to FIG. 7.

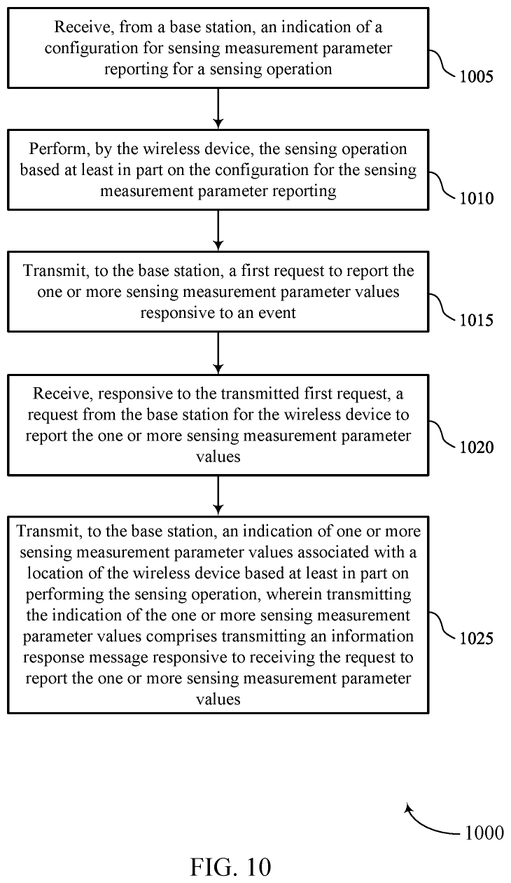

FIG. 10 shows a flowchart illustrating a method 1000 that supports techniques for adding surrounding information in MDT reporting in accordance with aspects of the present disclosure. The operations of the method 1000 may be implemented by a wireless device or its components as described herein. For example, the operations of the method 1000 may be performed by a wireless device as described with reference to FIGS. 1 through 8. In some examples, a wireless device may execute a set of instructions to control the functional elements of the wireless device to perform the described functions. Additionally or alternatively, the wireless device may perform aspects of the described functions using special-purpose hardware.

At 1005, the method may include receiving, from a base station, an indication of a configuration for sensing measurement parameter reporting for a sensing operation. The operations of 1005 may be performed in accordance with examples as disclosed herein. In some examples, aspects of the operations of 1005 may be performed by a configuration component 725 as described with reference to FIG. 7.

At 1010, the method may include performing, by the wireless device, the sensing operation based on the configuration for the sensing measurement parameter reporting. The operations of 1010 may be performed in accordance with examples as disclosed herein. In some examples, aspects of the operations of 1010 may be performed by a sensing operation component 730 as described with reference to FIG. 7.

At 1015, the method may include transmitting, to the base station, a first request to report the one or more sensing measurement parameter values responsive to an event. The operations of 1015 may be performed in accordance with examples as disclosed herein. In some examples, aspects of the operations of 1015 may be performed by a request component 740 as described with reference to FIG. 7.

At 1020, the method may include receiving, responsive to the transmitted first request, a request from the base station for the wireless device to report the one or more sensing measurement parameter values. The operations of 1020 may be performed in accordance with examples as disclosed herein. In some examples, aspects of the operations of 1020 may be performed by a request component 740 as described with reference to FIG. 7.

At 1025, the method may include transmitting, to the base station, an indication of one or more sensing measurement parameter values associated with a location of the wireless device based on performing the sensing operation, where transmitting the indication of the one or more sensing measurement parameter values includes transmitting an information response message responsive to receiving the request to report the one or more sensing measurement parameter values. The operations of 1025 may be performed in accordance with examples as disclosed herein. In some examples, aspects of the operations of 1025 may be performed by a measurement parameter component 735 as described with reference to FIG. 7.

The following provides an overview of aspects of the present disclosure:

Aspect 1: A method for wireless communication at a wireless device, comprising: receiving, from a base station, an indication of a configuration for sensing measurement parameter reporting for a sensing operation; performing, by the wireless device, the sensing operation based at least in part on the configuration for the sensing measurement parameter reporting; and transmitting, to the base station, an indication of one or more sensing measurement parameter values associated with a location of the wireless device based at least in part on performing the sensing operation.

Aspect 2: The method of aspect 1, further comprising: transmitting, to the base station, a first request to report the one or more sensing measurement parameter values responsive to an event; receiving, responsive to the transmitted first request, a request from the base station for the wireless device to report the one or more sensing measurement parameter values, wherein transmitting the indication of the one or more sensing measurement parameter values comprises transmitting an information response message responsive to receiving the request to report the one or more sensing measurement parameter values.

Aspect 3: The method of aspect 2, wherein the event comprises a RLF, an SCG failure, a CEF, or any combination thereof.

Aspect 4: The method of any of aspects 2 through 3, wherein the information response message is transmitted via RRC signaling.

Aspect 5: The method of any of aspects 1 through 4, wherein transmitting the indication of the one or more sensing measurement parameter values comprises: transmitting, to the base station, a report associated with a quality of experience.

Aspect 6: The method of any of aspects 1 through 5, further comprising: determining CSI based at least in part on the sensing operation, wherein the indication of the one or more sensing measurement parameter values are based at least in part on the determined CSI.

Aspect 7: The method of aspect 6, wherein the one or more sensing measurement parameter values comprise one or more of UE space information, one or more enclosed space dimensions, an enclosed space type, people information, animal information, object information, material type information, or a UE motion state.

Aspect 8: The method of any of aspects 1 through 7, further comprising: estimating the one or more sensing measurement parameter values based at least in part on performing the sensing operation, wherein the transmitted indication of the one or more sensing measurement parameter values comprises an indication of the estimated one or more sensing measurement parameter values transmitted on a set of resources indicated by the configuration.

Aspect 9: The method of any of aspects 1 through 8, further comprising: obtaining sensing data according to the configuration and based at least in part on performing the sensing operation, wherein the transmitted indication of the one or more sensing measurement parameter values comprise the sensing data.

Aspect 10: The method of any of aspects 1 through 9, wherein the configuration identifies for the wireless device to report the one or more sensing measurement parameter values as at least a part of a periodic RRM measurement report.

Aspect 11: The method of any of aspects 1 through 10, further comprising: determining a performance metric satisfies a threshold based at least in part on the configuration, wherein the sensing operation is performed based at least in part on determining the performance metric satisfies the threshold.

Aspect 12: The method of aspect 11, wherein the performance metric comprises an RSRP, an RSRQ, a SINR, or any combination thereof.

Aspect 13: The method of any of aspects 1 through 12, further comprising: performing the sensing operation based at least in part on detecting an event; storing the one or more sensing measurement parameter values based at least in part on performing the sensing operation; and receiving, from the base station, an indication to transmit the stored one or more sensing measurement parameter values, the indication of the stored one or more sensing measurement parameter values transmitted to the base station at least in part in response to receiving the indication to transmit the stored one or more sensing measurement parameter values.

Aspect 14: The method of aspect 13, wherein the wireless device is operating in an idle mode or an inactive mode.

Aspect 15: The method of any of aspects 13 through 14, wherein the event comprises the wireless device entering an out-of-coverage area.

Aspect 16: The method of any of aspects 1 through 15, further comprising: performing the sensing operation based at least in part on one or more machine learning capabilities at the wireless device.

Aspect 17: The method of any of aspects 1 through 16, wherein the sensing operation is performed using mmWave frequencies.

Aspect 18: The method of any of aspects 1 through 17, wherein the wireless device comprises a UE or a DU of an IAB node.

Aspect 19: An apparatus for wireless communication at a wireless device, comprising a processor; memory coupled with the processor; and instructions stored in the memory and executable by the processor to cause the apparatus to perform a method of any of aspects 1 through 18.

Aspect 20: An apparatus for wireless communication at a wireless device, comprising at least one means for performing a method of any of aspects 1 through 18.

Aspect 21: A non-transitory computer-readable medium storing code for wireless communication at a wireless device, the code comprising instructions executable by a processor to perform a method of any of aspects 1 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a wireless device, comprising:
receiving, from a base station, an indication of a configuration for sensing measurement parameter reporting for a sensing operation;
performing, by the wireless device, the sensing operation based at least in part on the configuration for the sensing measurement parameter reporting; and
transmitting, to the base station, an indication of one or more sensing measurement parameter values associated with a location of the wireless device based at least in part on performing the sensing operation.

2. The method of claim 1, further comprising:
transmitting, to the base station, a first request to report the one or more sensing measurement parameter values responsive to an event; and
receiving, responsive to the transmitted first request, a request from the base station for the wireless device to report the one or more sensing measurement parameter values, wherein transmitting the indication of the one or more sensing measurement parameter values comprises transmitting an information response message responsive to receiving the request to report the one or more sensing measurement parameter values.

3. The method of claim 2, wherein the event comprises a radio link failure, a secondary cell group failure, a connection establishment failure, or any combination thereof.

4. The method of claim 2, wherein the information response message is transmitted via radio resource control signaling.

5. The method of claim 1, wherein transmitting the indication of the one or more sensing measurement parameter values comprises:
transmitting, to the base station, a report associated with a quality of experience.

6. The method of claim 1, further comprising:
determining channel state information based at least in part on the sensing operation, wherein the indication of the one or more sensing measurement parameter values are based at least in part on the determined channel state information.

7. The method of claim 6, wherein the one or more sensing measurement parameter values comprise one or more of user equipment (UE) space information, one or more enclosed space dimensions, an enclosed space type, people information, animal information, object information, material type information, or a UE motion state.

8. The method of claim 1, further comprising:
estimating the one or more sensing measurement parameter values based at least in part on performing the sensing operation, wherein the transmitted indication of the one or more sensing measurement parameter values comprises an indication of the estimated one or more sensing measurement parameter values transmitted on a set of resources indicated by the configuration.

9. The method of claim 1, further comprising:
obtaining sensing data according to the configuration and based at least in part on performing the sensing operation, wherein the transmitted indication of the one or more sensing measurement parameter values comprise the sensing data.

10. The method of claim 1, wherein the configuration identifies for the wireless device to report the one or more sensing measurement parameter values as at least a part of a periodic radio resource management measurement report.

11. The method of claim 1, further comprising:
determining a performance metric satisfies a threshold based at least in part on the configuration, wherein the sensing operation is performed based at least in part on determining the performance metric satisfies the threshold.

12. The method of claim 11, wherein the performance metric comprises a reference signal received power, a reference signal received quality, a signal to interference plus noise ratio, or any combination thereof.

13. The method of claim 1, further comprising:
performing the sensing operation based at least in part on detecting an event;
storing the one or more sensing measurement parameter values based at least in part on performing the sensing operation; and
receiving, from the base station, an indication to transmit the stored one or more sensing measurement parameter values, the indication of the stored one or more sensing measurement parameter values transmitted to the base station at least in part in response to receiving the indication to transmit the stored one or more sensing measurement parameter values.

14. The method of claim 1, wherein the wireless device comprises a user equipment or a distributed unit of an integrated access and backhaul node.

15. An apparatus for wireless communication at a wireless device, comprising:
a processor;
memory coupled with the processor; and
instructions stored in the memory and executable by the processor to cause the apparatus to:
receive, from a base station, an indication of a configuration for sensing measurement parameter reporting for a sensing operation;
perform the sensing operation based at least in part on the configuration for the sensing measurement parameter reporting; and
transmit, to the base station, an indication of one or more sensing measurement parameter values associated with a location of the wireless device based at least in part on performing the sensing operation.

16. The apparatus of claim 15, wherein the instructions are further executable by the processor to cause the apparatus to:
transmit, to the base station, a first request to report the one or more sensing measurement parameter values responsive to an event; and
receive, responsive to the transmitted first request, a request from the base station for the wireless device to report the one or more sensing measurement parameter values, wherein transmitting the indication of the one or more sensing measurement parameter values comprises transmitting an information response message responsive to receiving the request to report the one or more sensing measurement parameter values.

17. The apparatus of claim 16, wherein the event comprises a radio link failure, a secondary cell group failure, a connection establishment failure, or any combination thereof.

18. The apparatus of claim 16, wherein the information response message is transmitted via radio resource control signaling.

19. The apparatus of claim 15, wherein the instructions to transmit the indication of the one or more sensing measurement parameter values are executable by the processor to cause the apparatus to:
transmit, to the base station, a report associated with a quality of experience.

20. The apparatus of claim 15, wherein the instructions are further executable by the processor to cause the apparatus to:
determine channel state information based at least in part on the sensing operation, wherein the indication of the one or more sensing measurement parameter values are based at least in part on the determined channel state information.

21. The apparatus of claim 20, wherein the one or more sensing measurement parameter values comprise one or more of user equipment (UE) space information, one or more enclosed space dimensions, an enclosed space type, people information, animal information, object information, material type information, or a UE motion state.

22. The apparatus of claim 15, wherein the instructions are further executable by the processor to cause the apparatus to:
estimate the one or more sensing measurement parameter values based at least in part on performing the sensing operation, wherein the transmitted indication of the one or more sensing measurement parameter values comprises an indication of the estimated one or more sensing measurement parameter values transmitted on a set of resources indicated by the configuration.

23. The apparatus of claim 15, wherein the instructions are further executable by the processor to cause the apparatus to:
obtain sensing data according to the configuration and based at least in part on performing the sensing operation, wherein the transmitted indication of the one or more sensing measurement parameter values comprise the sensing data.

24. The apparatus of claim 15, wherein the configuration identifies for the wireless device to report the one or more sensing measurement parameter values as at least a part of a periodic radio resource management measurement report.

25. The apparatus of claim 15, wherein the instructions are further executable by the processor to cause the apparatus to:
determine a performance metric satisfies a threshold based at least in part on the configuration, wherein the sensing operation is performed based at least in part on determining the performance metric satisfies the threshold.

26. The apparatus of claim 25, wherein the performance metric comprises a reference signal received power, a reference signal received quality, a signal to interference plus noise ratio, or any combination thereof.

27. The apparatus of claim 15, wherein the instructions are further executable by the processor to cause the apparatus to:
perform the sensing operation based at least in part on detecting an event;
store the one or more sensing measurement parameter values based at least in part on performing the sensing operation; and
receive, from the base station, an indication to transmit the stored one or more sensing measurement parameter values, the indication of the stored one or more sensing measurement parameter values transmitted to the base station at least in part in response to receiving the indication to transmit the stored one or more sensing measurement parameter values.

28. The apparatus of claim 15, wherein the wireless device comprises a user equipment or a distributed unit of an integrated access and backhaul node.

29. An apparatus for wireless communication at a wireless device, comprising:
means for receiving, from a base station, an indication of a configuration for sensing measurement parameter reporting for a sensing operation;
means for performing the sensing operation based at least in part on the configuration for the sensing measurement parameter reporting; and
means for transmitting, to the base station, an indication of one or more sensing measurement parameter values associated with a location of the wireless device based at least in part on performing the sensing operation.

30. A non-transitory computer-readable medium storing code for wireless communication at a wireless device, the code comprising instructions executable by a processor to:
receive, from a base station, an indication of a configuration for sensing measurement parameter reporting for a sensing operation;
perform the sensing operation based at least in part on the configuration for the sensing measurement parameter reporting; and
transmit, to the base station, an indication of one or more sensing measurement parameter values associated with a location of the wireless device based at least in part on performing the sensing operation.
